(19) United States
(12) Patent Application Publication
(10) Pub. No.: US 2024/0098475 A1
(43) Pub. Date: Mar. 21, 2024

(54) Detection of Co-Located Access Points for Roaming in Wireless Devices

(71) Applicant: ZEBRA TECHNOLOGIES CORPORATION, Lincolnshire, IL (US)

(72) Inventors: Jonathan Chen, Medford, NY (US); Mahendiran Balasubramaniyam, Erode (IN)

(21) Appl. No.: 17/947,253

(22) Filed: Sep. 19, 2022

(51) Int. Cl. H04W 8/00; H04W 24/10; H04W 48/20; H04W 76/10

(52) U.S. Cl. CPC H04W 8/005; H04W 24/10; H04W 48/20; H04W 76/10

(57) ABSTRACT

A method includes: establishing a connection with a wireless network; performing a roam scan to detect a plurality of access points of the wireless network; determining that a first access point of the plurality of detected access points satisfies a signal strength criterion; determining that a second access point of the plurality of detected access points is physically co-located with the first access point; and selecting a roaming destination from the first access point and the second access point.

### BACKGROUND

A wireless computing device roaming between access points implementing a wireless network may evaluate the access points to omit from roaming consideration any access points with measured signal strengths that do not exceed the signal strength of an AP currently connected to the device by at least a threshold amount. Such omission, however, can lead to suboptimal roaming behavior.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a diagram of a wireless communications system.

FIG. 2 is a flowchart of a method for detection of co-located access points for roaming.

FIG. 3 is a diagram illustrating an example performance of block 210 of the method of FIG. 2.

FIG. 4 is a diagram illustrating an example performance of blocks 215 and 220 of the method of FIG. 2.

FIG. 5 is a diagram illustrating an example performance of blocks 225 and 230 of the method of FIG. 2.

FIG. 6 is a flowchart of another method for detection of co-located access points for roaming.

FIG. 7 is a diagram illustrating an example performance of the method of FIG. 6.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a method in a controller, the method comprising: establishing a connection with a wireless network; performing a roam scan to detect a plurality of access points of the wireless network; determining that a first access point of the plurality of detected access points satisfies a signal strength criterion; determining that a second access point of the plurality of detected access points is physically co-located with the first access point; and selecting a roaming destination from the first access point and the second access point.

Additional examples disclosed herein are directed to a wireless computing device, comprising: a memory; a communications interface; and a processor configured to: establish a connection with a wireless network; perform a roam scan to detect a plurality of access points of the wireless network; determine that a first access point of the plurality of detected access points satisfies a signal strength criterion; determine that a second access point of the plurality of detected access points is physically co-located with the first access point; and select a roaming destination from the first access point and the second access point.

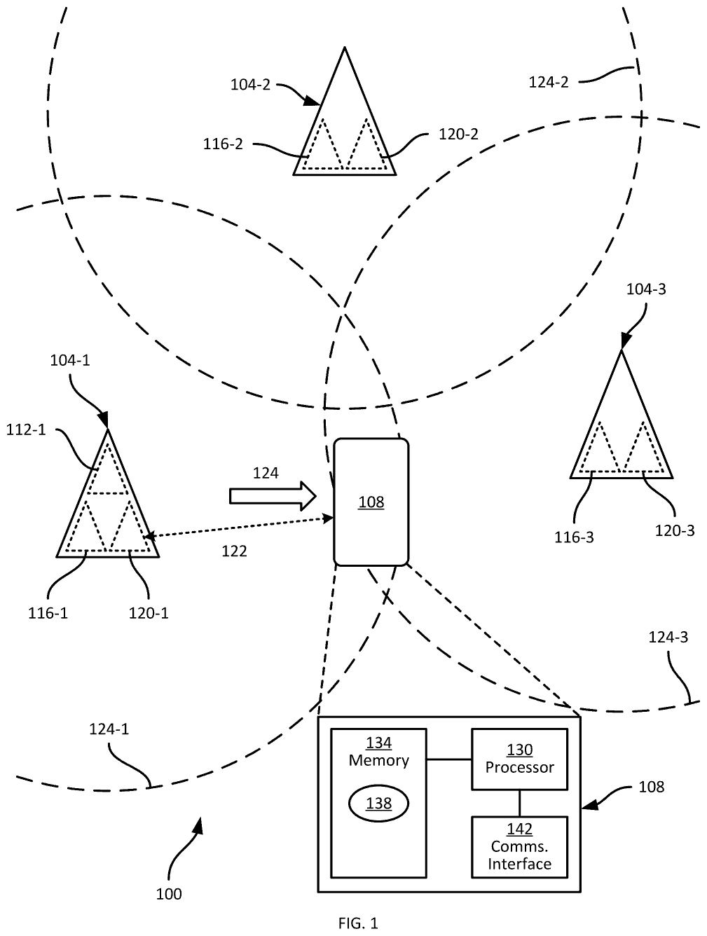

FIG. 1 illustrates a wireless communications system 100, deploying one or more wireless networks, such as wireless local area networks (WLANs) based on the Institute of Electrical and Electronics Engineers (IEEE) 802.11 family of standards (e.g., one or more Wi-Fi networks). The system 100 includes a plurality of physical access points (APs) 104-1, 104-2, and 104-3, collectively referred to as the access points 104, and generically referred to as an access point 104 (similar nomenclature may be used elsewhere herein). The system 100 can include two access points 104, or more than three access points 104, in other examples.

The physical APs 104 are referred to as such because each physical AP 104 includes an enclosure housing one or more controllers, transceivers, antenna assemblies, and the like. A given network, identified by a service set identifier (SSID), can be implemented by a plurality of APs. For example, the network can be implemented by distinct APs operating at different frequency bands, such as one or more of a 2.4 GHz band, a 5 GHz band, a 6 GHz band, and the like. Client devices within the network, such as a wireless computing device 108 (e.g., a mobile computer, a smartphone, a mobile printer, a barcode scanner, a tablet computer, or the like), can roam between the access points implementing the network, according to signal strength, congestion, band preferences at the client devices, and the like.

The access points implementing the network need not be physically distinct from one another. For example, each physical access point 104 can include sufficient hardware resources (e.g., transceivers, controllers, antenna arrays, and the like) to implement more than one access point. In the illustrated example, the physical AP 104-1 implements three APs 112-1, 116-1, and 120-1. The physical AP 104-2 implements two APs 116-2 and 120-2, and the physical AP 104-3 implements two APs 116-3 and 120-3. The APs 112, 116, and 120 all implement a common network, e.g., having a single SSID. Further, in this example the AP 112-1 operates on a 2.4 GHz band, while the APs 116 operate on a 5 GHz band, and the APs 120 operate on a 6 GHz band. The network, in other words, is deployed by seven APs, which are housed in three distinct physical APs 104.

The device 108 is illustrated as having established a connection 122 with the AP 120-1. As the device 108 travels, e.g., in a direction 124, the device 108 may approach an outer extent of a coverage area 124-1 associated with the physical AP 104-1, and enter a coverage area 124-3 associated with the physical AP 104-3. FIG. 1 illustrates single coverage areas 124-1, 124-2, and 124-3 for the physical APs 104, although it will be understood that the coverage area (that is, the area over which the device 108 can establish a connection with an AP 112, 116, or 120) may vary according to individual APs 112, 116, and 120, e.g., based on the presence of obstacles such as walls, and on the transmit power and frequency of each AP 112, 116, and 120. For example, the APs 120 (operating on the 6 GHz band) may employ reduced transmit power relative to the APs 112 and 116, and/or may be more susceptible to interference from obstacles. Coverage for an AP 120 may therefore be reduced relative to coverage for an AP 112 and/or 116.

When the device 108 approaches the outer extent of the coverage area 124-1 and enters the coverage area 124-3, the device 108 may detect a roaming condition (also referred to as a roam trigger), such as a reduction in signal strength (e.g., a Received Signal Strength Indicator, or RSSI) from the AP 120-1 below a threshold. In response to detecting the roam trigger, the device 108 can collect data identifying a plurality of access points, such as the APs 112-1, 116-1, 120-1, 116-3, and 120-3, to be evaluated as candidates for roaming to. Each of the above-mentioned APs may have a distinct identifier (e.g., a Basic Service Set Identifier or BSSID). The identifier of each AP can include a Media Access Control (MAC) address. Each physical AP 104 can include a controller configured to assign virtual MAC addresses to the individual APs implemented at that physical AP 104, to allow the device 108 to distinguish between and selectively connect with individual APs 112, 116, and 120.

Having collected the data identifying the above-mentioned APs 112, 116, and 120, the device 108 can be configured to retain for further evaluation only those APs that satisfy a signal strength criterion. Also referred to as an RSSI delta check, the signal strength criterion for a given roaming candidate AP can include a comparison of a signal strength measurement from the AP 120-1 (to which the device 108 is currently connected) with a signal strength measurement from the roaming candidate AP. When the signal strength measurement from the roaming candidate AP exceeds the signal strength measurement from the AP 120-1 by at least a threshold amount (e.g., a threshold corresponding to a different in received power of about 5 dBm, although a wide variety of other thresholds and measurement units are also contemplated), the roaming candidate AP can be retained at the device 108 for further evaluation. When the difference does not exceed the threshold, the roaming candidate AP can be discarded. The signal strength criterion can mitigate frequent roam operations back and forth between APs as the device 108 travels between APs.

The signal strength criterion, however, can also lead to the omission of suitable roaming candidates at the device 108. For example, with the device 108 in the position shown in FIG. 1 relative to the physical APs 104-1 and 104-3, the AP 116-3 (a 5 GHz radio) may satisfy the signal strength criterion, while the AP 120-3 may not satisfy the signal strength criterion, despite being physically co-located with the AP 116-3. The device 108 may therefore not consider the AP 120-3 as a roaming candidate, and may instead roam to the AP 116-3. The AP 120-3, however, may be a preferable roaming candidate for various other reasons despite currently presenting a sub-optimal signal strength, such as greater available throughput, reduced congestion, or the like. Further, the detection of a suitable signal strength from the AP 116-3 likely indicates that the AP 120-3 is a suitable candidate for roaming despite not having satisfied the signal strength criterion.

The device 108 is configured to implement roaming functionality, discussed below in greater detail, that mitigates the omission of suitable roaming candidates by discovering whether APs are physically co-located (e.g., as in the case of the APs 116-3 and 120-3), and exempting certain APs from the signal strength criterion mentioned above under some conditions. As a result of this functionality, the device 108 can therefore retain not only the AP 116-3, but also the AP 120-3, as roaming candidates, and can select the AP 120-3 as a roaming destination, rather than being forced to select the AP 116-3 in the absence of other options.

Certain internal components of the device 108 are also illustrated in FIG. 1. The device 108 includes a processor 130, such as a central processing unit (CPU) and/or graphics processing unit (GPU), application-specific integrated circuit (ASIC), or the like, communicatively coupled with a non-transitory computer-readable storage medium such as a memory 134, e.g., a combination of volatile memory elements (e.g., random access memory (RAM)) and non-volatile memory elements (e.g., flash memory or the like). The memory 134 stores a plurality of computer-readable instructions in the form of applications, including in the illustrated example a wireless communications application 138 whose execution by the processor 130 configures the device 108 to perform the roaming functionality described herein.

The device 108 also includes a communications interface 142, enabling the device 108 to establish connections with WLANs, such as the network implemented by the APs mentioned above and shown in FIG. 1. The communications interface 142 can therefore include any suitable combination of transceivers, antenna elements, and corresponding control hardware enabling communications with the APs 112, 116, and 120. In some examples, the application 138 resides within the communications interface 142 and is executed by a controller of the communications interface 142 distinct from the processor 130.

The device 108 can include further components (not shown), including output devices such as a display, a speaker, and the like, as well as input devices such as a keypad, a touch screen, a microphone, and the like.

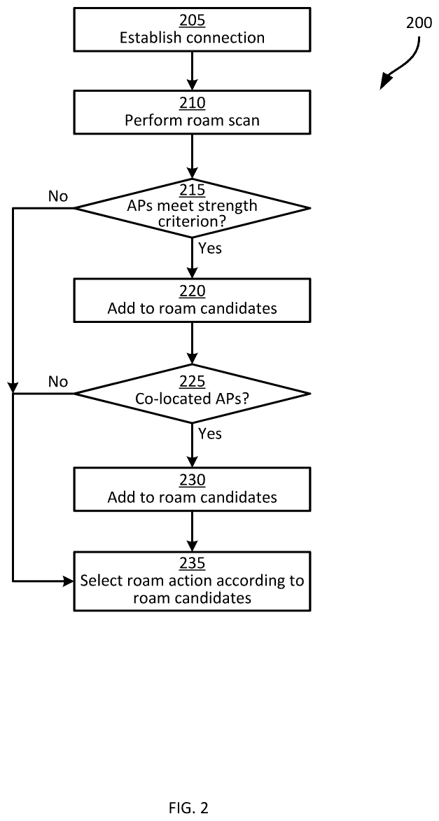

Turning to FIG. 2, a method 200 of detection of co-located access points for roaming is illustrated. The method 200 is described below in conjunction with its example performance in the system 100, by the device 108.

At block 205, the device 108 is configured to establish a connection with the network, e.g., with a selected one of the APs implementing the network. As shown in FIG. 1, the device 108 established the connection 122 with the AP 120-1. At block 210, the device 108 is configured to perform a roam scan, e.g., in response to detecting a roam trigger condition. The roam trigger can include, for example, a reduction in signal strength from the currently connected AP (e.g., the AP 120-1, in this example) to below a threshold. Various other roam triggers can be implemented in addition to or instead of a signal strength threshold. For example, the device 108 can monitor signal strength over time, and detect a roam trigger when a downward trend in signal strength with current connected AP 120-1 is observed. Detection of other roam triggers can include monitoring the connection 122 for congestion, or the like.

In response to detecting the roam trigger, the device 108 initiates the roam scan. The roam scan can include cycling the communications interface 142 through a plurality of frequency bands and/or channels within such bands, to detect beacon data broadcast periodically by each AP 112, 116, and 120. In some examples, the roam scan can also include transmitting probe requests, and receiving probe responses, from the APs 112, 116, and 120. Through performance of the roam scan, the device 108 detects a plurality of APs in the vicinity of the device 108, via the receipt of identifying data for each of the detected APs.

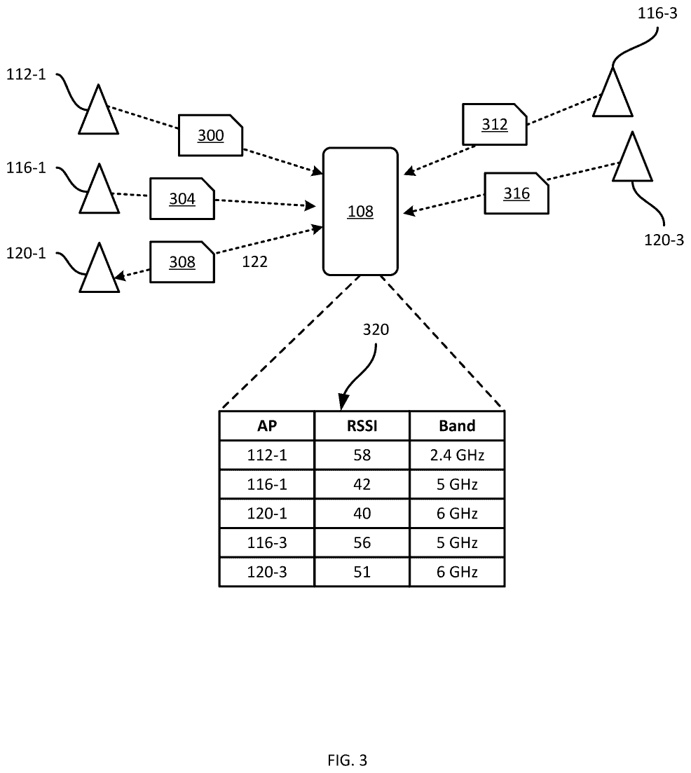

Turning to FIG. 3, a simplified example roam scan is illustrated, in which the device 108 receives respective identifying data 300, 304, 308, 312, and 316 from the APs 112-1, 116-1, 120-1, 116-3, and 120-3 (though not necessarily in that order). The identifying data 308, from the AP 120-1, can also be received over the connection 122 previously established with the device 108, or may already be available at the device 108 (e.g., in the memory 134) as a result of the connection 122.

The identifying data collected at block 210 can be stored at the device 108 for further processing. For example, FIG. 3 illustrates a table 320 indicating signal strength measurements, e.g., as RSSI values on a scale between zero and one hundred. A wide variety of other RSSI scales can be employed, and in other examples the signal strength measurements need not be expressed as RSSI values, but can instead be expressed as power measurements, e.g., in dBm. The data collected by the device 108 can also include AP identifiers, which in the illustrated example are represented by the reference numerals assigned to each AP in FIG. 1, but in other examples include BSSIDs identifying the APs. The data collected by the device 108 also includes, in this example, an indication of which band each AP operates within. In other examples, the data can include specific channel identifiers instead of, or in addition to, the band indicators. As will be understood by those skilled in the art, the device 108 can also obtain a wide variety of other information for each AP from the identifying data 300, 304, 308, 312, and 316, including compatibility with various networking features, clock synchronization data, and the like. As will also be discussed below, the identifying data can include indications, from one or more of the APs 112-1, 116-1, 120-1, 116-3, and 120-3, of other physically co-located APs.

Returning to FIG. 2, at block 215, the device 108 is configured to identify APs identified from the roam scan at block 210 that satisfy a signal strength criterion. Determining that a candidate AP satisfies the signal strength criterion includes determining a difference between a signal strength measurement from the candidate AP and the currently connected AP (the AP 120-1 in this example), and determining whether the difference exceeds a threshold. For example, the device 108 can be configured to determine whether any of the RSSI values obtained at block 210 exceed the RSSI of the “home” access point 120-1 (to which the device 108 is currently connected) by at least twelve. A wide variety of other thresholds can also be employed, as will be apparent to those skilled in the art.

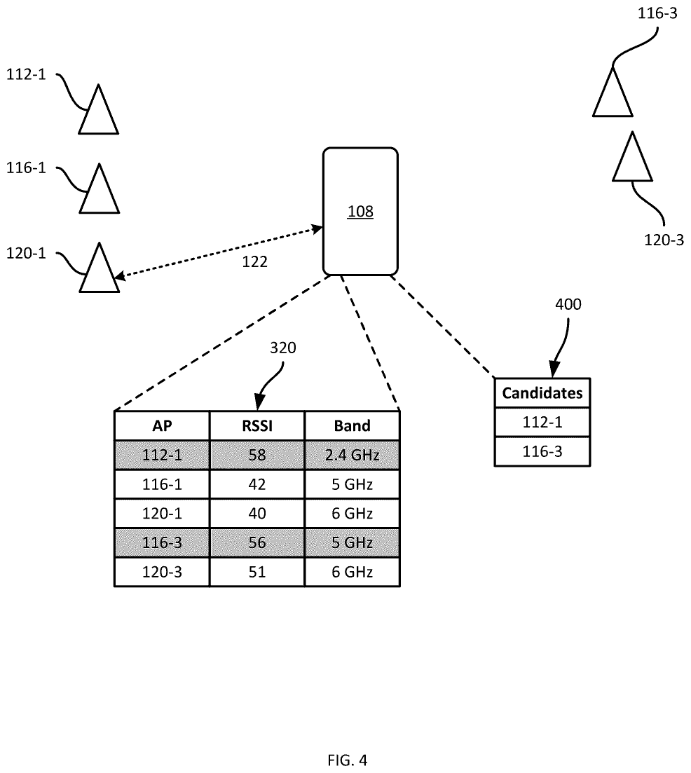

Turning to FIG. 4, an example performance of block 215 reveals that only the APs 112-1 and 116-3 satisfy the signal strength criterion set out above. Specifically, only the APs 112-1 and 116-3 correspond to RSSI values of 52 or greater. At block 220, the APs determined to meet the signal strength criterion can be added to a list of roam candidates for further evaluation, e.g., by flagging those APs in the table 320, storing AP identifiers and/or other information in a distinct roam candidate list 400, or the like.

As seen from FIG. 4, the AP 120-3 does not satisfy the signal strength condition, and is therefore not added to the roam candidates at block 220. The AP 120-3 may, however, be a suitable roam candidate despite a marginal RSSI value, and the device 108 therefore implements an additional selection mechanism before selecting a destination AP to roam to.

Referring again to FIG. 2, at block 225, the device 108 is configured to identify APs, from those detected at block 210, that are physically co-located with APs from block 220 (i.e., for which an affirmative determination was made at block 215). When a first AP (e.g., the AP 116-3) satisfies the signal strength criterion, a second AP (e.g., the AP 120-3) that is physically co-located with the first AP may be a suitable roaming candidate, even if the second AP does not satisfy the signal strength condition. The performance of block 225 by the device 108 aims to avoid omitting such a second AP from the roam candidates.

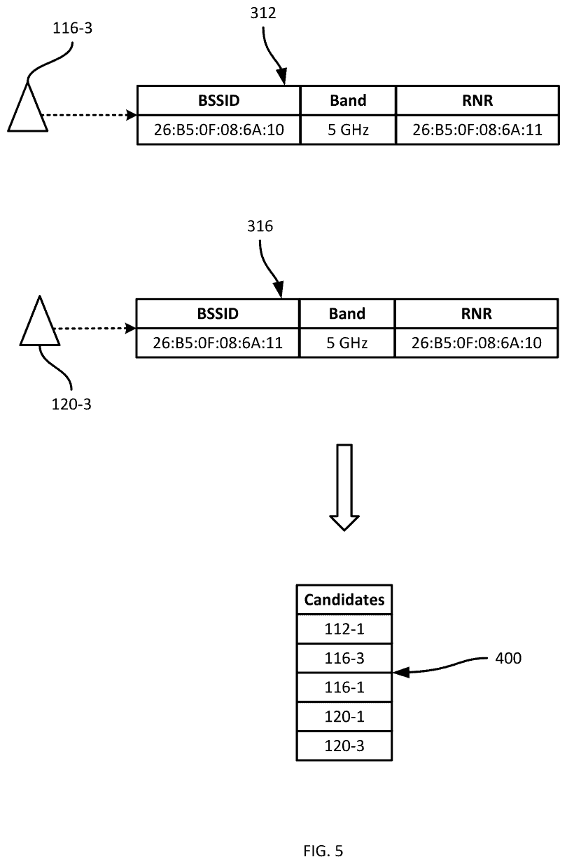

The device 108 can identify co-located APs at block 225 from the identifying data obtained at block 210. In some examples, the device 108 can extract an identifier of a co-located AP directly from identifying data received from an AP. Turning to FIG. 5, for example, the identifying data 312 and 316 obtained from the APs 116-3 and 120-3 are shown. Among the information included in the identifying data 312 is an identifier, such as a BSSID, of the AP 116-3, as well as a co-located AP field. The co-located AP field can be implemented as a Reduced Neighbor Report (RNR) information element, and contains the identifier(s) (e.g., the BSSIDs) of any other APs that are co-located with the AP 116-3. That is, the AP 116-3 stores such identifiers locally, and can include the identifiers in beacon frames, probe response frames, and the like, in the RNR element. From the RNR element, therefore, the device 108 can extract the identifier of the AP 120-3, and add the AP 120-3 to the roam candidate list 400 at block 230.

In some systems, certain APs may make use of the RNR element, while other APs may omit the RNR element. The device 108 can therefore determine, at block 225, whether any APs added to the roam candidate list 400 at block 220 provided RNR elements identifying other APs. The device 108 can also determine at block 225 whether any of the APs that did not satisfy the determination at block 215 provided RNR elements identifying other APs that appear on the roam candidate list 400.

In other examples, instead of or in addition to the use of the RNR or other suitable elements that explicitly identify co-located APs, the device 108 can be configured to identify co-located APs based on comparisons of AP identifiers such as the BSSIDs shown in FIG. 5. In particular, as noted earlier, the controller of a physical AP 104 can be configured to assign virtual MAC addresses as BSSIDs to the APs implemented by that physical AP 104. The virtual MAC addresses assigned to APs within a given physical AP 104 often differ only in the final two octets. For example, as shown in FIG. 5, the first five octets of the BSSIDs for both the AP 116-3 and the AP 120-3 are “26:B5:0F:08:6A”. The BSSIDs of the APs 116-3 and 120-3, in other words, differ only in the final two octets, and are therefore separated by a value of no more than fifteen. The device 108 can therefore be configured to determine, for the AP 116-3 for example, whether any other AP detected at block 210 has a BSSID that is different from the BSSID of the AP 116-3 by fifteen or less. When such an AP is identified (e.g., the AP 120-3), the identified AP is assumed to be co-located with the AP 116-3 and is therefore added to the roam candidate list 400 at block 230.

As will now be apparent, the identification of co-located APs at block 225, in the specific example illustrated in FIG. 3, leads to the addition of the APs 116-1 and 120-1, as well as the AP 120-3, to the roam candidate list 400. In some examples, the home AP (the AP 120-1, in this example) can also be added to the roam candidate list 400 prior to performing block 215.

Following the performance of blocks 215, 220 and 225 (as well as 230 if co-located APs are present), or following a negative determination at block 215 or block 225, the device 108 proceeds to block 235. At block 235, the device 108 is configured to select a roam action according to the roam candidates (e.g., according to the list 400). A wide variety of mechanisms can be implemented to select a roam action. For example, the device 108 can be configured to select a destination AP to roam to by scoring or otherwise prioritizing each of the APs on the list 400, and selected the highest-scoring AP. Scoring or prioritizing can be based on any combination of signal strength measurements, operating band (e.g., relative to a preferred operating band stored at the device 108), measured congestion, and the like.

The performance of blocks 225 and 230 allow the device 108 to retain as roam candidates APs that may otherwise be discarded as roam candidates due to insufficient signal strength. In the example illustrated in FIGS. 1-5, the device 108 may select the AP 120-3 as a roam destination, for example, due to the operation of the AP 120-3 on a preferred band (e.g., 6 GHz).

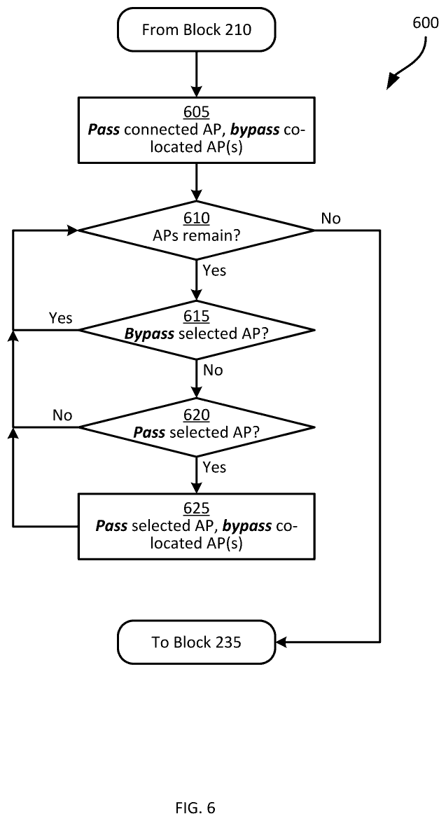

While the discussion above of the roaming functionality implemented by the device 108 contemplates evaluating the signal strength criterion for each discovered AP before identifying co-located APs, in other examples, the device 108 can traverse the list of APs discovered at block 210 in sequence. For example, turning to FIG. 6, a method 600 of implementing blocks 215 to 230 in a sequential manner is illustrated.

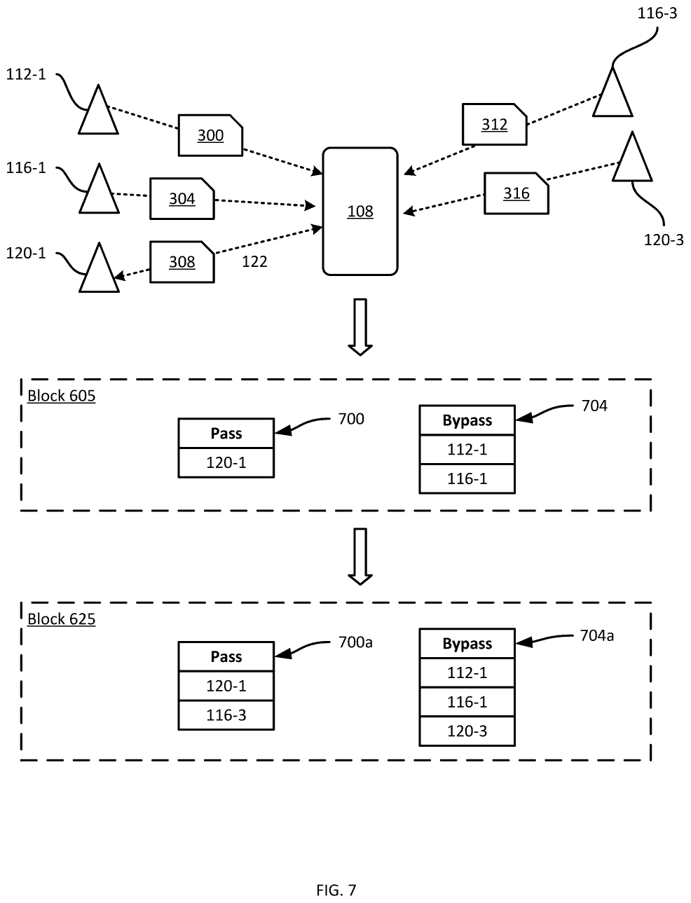

At block 605, having obtained identifying data (e.g., the identifying data 300, 304, 308, 312, and 316 from the APs 112-1, 116-1, 120-1, 116-3, and 120-3) at block 210, the device 108 can be configured to add the currently connected AP (e.g., the AP 120-1) to a “pass” list of devices satisfying the signal strength criterion. The device 108 can also be configured to add any co-located APs identified in an RNR element and/or by BSSID similarity to a “bypass” list. FIG. 7 illustrates an example pass list 700, and an example bypass list 704. The pass list 700 is used to store identifiers of APs from block 210 that have satisfied the signal strength criterion (except for the home AP 120-1, which cannot satisfy the signal strength criterion). The bypass list 704 is used to store identifiers of APs from block 210 that are exempted from the signal strength criterion, and therefore may be selected as roaming destinations even if they do not satisfy the signal strength criterion. Addition of APs to the bypass list 704 at block 605 is performed as discussed above in connection with FIG. 5.

At block 610, the device 108 is configured to determine whether discovered APs remain to be processed. When the determination is affirmative, the device 108 selects the next AP, e.g., in descending order of signal strength measurement, and proceeds to block 615. Using the signal strength measurements from FIG. 3, therefore at block 615 the device 108 selects the AP 112-1, and at block 615 determines whether the AP 112-1 appears in the bypass list 704. The determination is affirmative (because the AP 112-1 was added to the list 704 at block 605, being co-located with the home AP 120-1), and the device 108 therefore returns to block 610. Selecting the AP 116-3 at block 610, the device 108 determines that the AP 116-3 is not on the bypass list 704 at block 615, and proceeds to block 620. At block 620 (corresponding to a performance of block 215 of the method 200 specifically for the AP 116-3), the device 108 determines that the AP 116-3 does satisfy the signal strength criterion, and at block 625, adds the AP 116-3 to the pass list 700.

At block 625, the device 108 also adds the AP 120-3 to the bypass list 704, as the AP 120-3 is co-located with the AP 116-3. FIG. 7 illustrates updated lists 700a and 704a obtained by the performance of block 625. Block 625, in other words, corresponds to a performance of blocks 220, 225, and 230 for a particular AP. The device 108 then returns to block 610. As will now be apparent, the AP 120-3 is selected next (having the next-highest RSSI as shown in FIG. 3), and the determination at block 615 for the AP 120-3 is affirmative. As will also be apparent, the determinations at block 615 for the AP 116-1 is also affirmative, as the AP 116-1 was previously added to the bypass list 704a.

When no APs remain to be processed, the determination at block 610 is negative, and the device 108 proceeds to block 325, to select a roaming destination from the APs identified in both the lists 700a and 704a.

The device 108 can also implement additional roam trigger criteria, in some examples. In particular, the device 108 can be configured to maintain a preferred band indication, e.g., indicating that APs operating in the 6 GHz band are preferentially selected, when available. In addition to other roam trigger criteria used to initiate a roam scan at block 210, the device 108 can also determine whether an AP co-located with the currently connected AP exists (e.g., from the results of a previous performance of block 210) and operates in the preferred band. When the determination is affirmative, the device 108 can initiate a roam scan, as described above.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method in a controller, the method comprising:
establishing a connection with a wireless network;
performing a roam scan to detect a plurality of access points of the wireless network;
determining that a first access point of the plurality of detected access points satisfies a signal strength criterion;
determining that a second access point of the plurality of detected access points is physically co-located with the first access point; and
selecting a roaming destination from the first access point and the second access point.

2. The method of claim 1, wherein establishing a connection with the wireless network includes:
establishing a connection with a current access point of the plurality of access points; and
wherein determining that the first access point satisfies the signal strength criterion includes:
determining that a difference between a signal strength of the first access point and a signal strength of the current access point exceeds a threshold.

3. The method of claim 1, wherein determining that the second access point is physically co-located with the first access point includes:
obtaining identifying data from the first access point during the roam scan; and
extracting an identifier of the second access point from the identifying data.

4. The method of claim 3, wherein the identifying data includes the identifier of the second access point, and an indication that the second access point is co-located with the first access point.

5. The method of claim 4, wherein the identifying data includes a reduced neighbor report (RNR) information element.

6. The method of claim 1, wherein determining that the second access point is physically co-located with the first access point includes:
comparing an identifier of the first access point with an identifier of the second access point.

7. The method of claim 6, wherein the comparing includes:
determining that a difference between a portion of an identifier of the first access point and a portion of an identifier of the second access point is less than a threshold.

8. The method of claim 7, wherein the portion of the identifier of the first access point includes at least one octet of a media access controller (MAC) address of the first access point; and
wherein the portion of the identifier of the second access point includes at least one corresponding octet of a media access controller (MAC) address of the second access point.

9. The method of claim 1, further comprising:
responsive to determining that the first access point satisfies the signal strength criterion, adding the first access point to a pass list.

10. The method of claim 9, further comprising:
responsive to determining that the second access point is physically co-located with the first access point, adding the second access point to a bypass list; and
selecting a roaming destination from the pass list and the bypass list.

11. A wireless computing device, comprising:
a memory;
a communications interface; and
a processor configured to:
establish a connection with a wireless network;
perform a roam scan to detect a plurality of access points of the wireless network;
determine that a first access point of the plurality of detected access points satisfies a signal strength criterion;
determine that a second access point of the plurality of detected access points is physically co-located with the first access point; and
select a roaming destination from the first access point and the second access point.

12. The wireless computing device of claim 11, wherein the processor is configured to establish a connection with the wireless network by:
establishing a connection with a current access point of the plurality of access points; and
wherein the processor is configured to determine that the first access point satisfies the signal strength criterion by:
determining that a difference between a signal strength of the first access point and a signal strength of the current access point exceeds a threshold.

13. The wireless computing device of claim 11, wherein the processor is configured to determine that the second access point is physically co-located with the first access point by:
obtaining identifying data from the first access point during the roam scan; and
extracting an identifier of the second access point from the identifying data.

14. The wireless computing device of claim 13, wherein the identifying data includes the identifier of the second access point, and an indication that the second access point is co-located with the first access point.

15. The wireless computing device of claim 14, wherein the identifying data includes a reduced neighbor report (RNR) information element.

16. The wireless computing device of claim 11, wherein the processor is configured to determine that the second access point is physically co-located with the first access point by:
comparing an identifier of the first access point with an identifier of the second access point.

17. The wireless computing device of claim 16, wherein the the processor is configured to compare the identifiers of the first and second access points by:
determining that a difference between a portion of an identifier of the first access point and a portion of an identifier of the second access point is less than a threshold.

18. The wireless computing device of claim 17, wherein the portion of the identifier of the first access point includes at least one octet of a media access controller (MAC) address of the first access point; and
wherein the portion of the identifier of the second access point includes at least one corresponding octet of a media access controller (MAC) address of the second access point.

19. The wireless computing device of claim 11, wherein the processor is configured to:
responsive to determining that the first access point satisfies the signal strength criterion, add the first access point to a pass list.

20. The wireless computing device of claim 19, wherein the processor is configured to:
responsive to determining that the second access point is physically co-located with the first access point, add the second access point to a bypass list; and
select a roaming destination from the pass list and the bypass list.
